(19) United States
(12) Patent Application Publication
(10) Pub. No.: US 2021/0006328 A1
(43) Pub. Date: Jan. 7, 2021

(54) METHOD AND APPARATUS FOR REDUCING POWER CONSUMPTION IN NON-TERRESTRIAL NETWORK

(71) Applicant: ELECTRONICS AND TELECOMMUNICATIONS RESEARCH INSTITUTE, Daejeon (KR)

(72) Inventor: Jae Heung KIM, Daejeon (KR)

(73) Assignee: ELECTRONICS AND TELECOMMUNICATIONS RESEARCH INSTITUTE, Daejeon (KR)

(21) Appl. No.: 16/912,574

(22) Filed: Jun. 25, 2020

(30) Foreign Application Priority Data
Jul. 1, 2019 (KR) 10-2019-0078964
May 28, 2020 (KR) 10-2020-0064249

(51) Int. Cl. H04B 7/185; H04W 76/28; H04L 1/18; H04W 72/04; H04W 72/14

(52) U.S. Cl. CPC H04B 7/18543; H04B 7/18532; H04B 7/18517; H04W 72/14; H04B 7/18519; H04L 1/1819; H04W 72/042; H04W 76/28

(57) ABSTRACT

An operation method of a terminal in a non-terrestrial network may comprise when a transmission operation of downlink data is started in an on-duration according to a discontinuous reception (DRX) cycle, starting a first timer indicating a first time interval required for a retransmission operation of the downlink data; starting a second timer when the first timer expires; performing a downlink monitoring operation in a second time interval according to the second timer; and when control information for the retransmission operation is received from a non-terrestrial node in the second time interval, receiving the downlink data from the non-terrestrial node in a downlink resource indicated by the control information, wherein the first timer is configured in consideration of a transmission delay between the non-terrestrial node and the terminal.

### CROSS-REFERENCE TO RELATED APPLICATIONS

This application claims priority to Korean Patent Applications No. 10-2019-0078964 filed on Jul. 1, 2019, and No. 10-2020-0064249 filed on May 28, 2020 with the Korean Intellectual Property Office (KIPO), the entire contents of which are hereby incorporated by reference.

### BACKGROUND

### 1. Technical Field

The present disclosure relates to a technique for communication in a non-terrestrial network (NTN), and more specifically, to a technique for reducing power consumption in a terminal.

### 2. Related Art

The communication system (hereinafter, a new radio (NR) communication system) using a higher frequency band (e.g., a frequency band of 6 GHz or higher) than a frequency band (e.g., a frequency band lower below 6 GHz) of the long term evolution (LTE) (or, LTE-A) is being considered for processing of soaring wireless data. The NR communication system may support not only a frequency band below 6 GHz but also 6 GHz or higher frequency band, and may support various communication services and scenarios as compared to the LTE communication system. For example, usage scenarios of the NR communication system may include enhanced mobile broadband (eMBB), ultra-reliable low-latency communication (URLLC), massive machine type communication (mMTC), and the like.

The NR communication network can provide communication services to terrestrial terminals. Recently, there is an increasing demand for communication services not only to the terrestrial terminals but also to non-terrestrial airplanes, drones, unmanned aerial vehicles (UAVs), UAV base stations (UBS), and satellites. For this, technologies for non-terrestrial networks (NTNs) are being discussed. The non-terrestrial networks can be implemented based on the NR technology. For example, in the non-terrestrial network, communication between a satellite and a terrestrial communication node (e.g., user equipment (UE)) or between non-terrestrial communication nodes (e.g., airplanes, UAVs, drones) may be performed based on the NR technology. In the non-terrestrial network, a satellite may perform a function of a base station in the NR communication network. Here, the non-terrestrial network may mean a long-distance communication network in terms of a communication range.

Meanwhile, in the non-terrestrial network, a terminal may perform communication using a 6 GHz to 90 GHz band. That is, high-speed data transmission can be performed using a wide bandwidth in the non-terrestrial network. Since a round trip delay (RTD) between a satellite and a terminal is long in the non-terrestrial network, a transmission and reception method and a control method according to a radio protocol considering this are required. In particular, methods for reducing power consumption of the terminal in the non-terrestrial network are needed.

### SUMMARY

Accordingly, exemplary embodiments of the present disclosure provide methods and apparatuses for reducing power consumption by considering a transmission latency in a non-terrestrial network (NTN).

According to a first exemplary embodiment of the present disclosure, an operation method of a terminal in a non-terrestrial network may comprise: when a transmission operation of downlink data is started in an on-duration according to a discontinuous reception (DRX) cycle, starting a first timer indicating a first time interval required for a retransmission operation of the downlink data; starting a second timer when the first timer expires; performing a downlink monitoring operation in a second time interval according to the second timer; and when control information for the retransmission operation is received from a non-terrestrial node in the second time interval, receiving the downlink data from the non-terrestrial node in a downlink resource indicated by the control information, wherein the first timer is configured in consideration of a transmission delay between the non-terrestrial node and the terminal.

The first timer may be configured for each hybrid automatic repeat request (HARQ) process in the non-terrestrial network.

The first time interval may be a minimum time interval required to allocate the downlink resource for the retransmission operation in the non-terrestrial network.

A length of the first time interval may be set to a multiple of the DRX cycle.

An ending time of the first time interval may be set to a starting time of the on-duration, an ending time of the on-duration, or an arbitrary time within the on-duration.

The first time interval may be a sum of a minimum time interval required to allocate the downlink resource for the retransmission operation in a terrestrial network and the transmission delay.

The first timer may be stopped when the transmission operation is completed successfully, and the first timer may continue to operate when the transmission operation fails.

The second timer may be stopped when the control information for the retransmission operation is received from the non-terrestrial node.

The operation method may further comprise receiving, from the non-terrestrial node, a message including information of the first timer and information of the second timer.

According to a second exemplary embodiment of the present disclosure, a terminal in a non-terrestrial network may comprise a processor; a memory electronically communicating with the processor; and instructions stored in the memory, wherein when the instructions are executed by the processor, the instructions cause the terminal to: when a transmission operation of uplink data is started in an on-duration according to a discontinuous reception (DRX) cycle, start a first timer indicating a first time interval required for a retransmission operation of the uplink data; start a second timer when the first timer expires; and retransmit the uplink data to a non-terrestrial node by using an uplink resource in a second time interval according to the second timer, wherein the first timer is configured in consideration of a transmission delay between the non-terrestrial node and the terminal.

The first timer may be configured for each hybrid automatic repeat request (HARQ) process in the non-terrestrial network.

The first time interval may be a minimum time interval required to allocate the downlink resource for the retransmission operation in the non-terrestrial network, and a length of the first time interval may be set to a multiple of the DRX cycle.

An ending time of the first time interval may be set to a starting time of the on-duration, an ending time of the on-duration, or an arbitrary time within the on-duration.

The first time interval may be a sum of a minimum time interval required to allocate the downlink resource for the retransmission operation in a terrestrial network and the transmission delay.

The uplink resource may be a radio resource indicated by downlink control information (DCI) received from the non-terrestrial node in the second time interval or a configured grant (CG) resource.

The instructions may further cause the terminal to receive, from the non-terrestrial node, a message including information of the first timer and information of the second timer.

According to a third exemplary embodiment of the present disclosure, an operation method of a non-terrestrial node in a non-terrestrial network may comprise: transmitting, to a terminal, a message including information of a first timer indicating a first time interval required for a retransmission operation of downlink data and information of a second timer indicating a second time interval in which a downlink monitoring operation is performed; performing a transmission operation of the downlink data in an on-duration according to a discontinuous reception (DRX) cycle; and when the transmission operation fails, transmitting control information for the retransmission operation to the terminal in the second time interval after the first time interval, wherein the first time interval starts from a time of performing the transmission operation, the second time interval starts from an ending time of the first time interval, and the first timer is configured in consideration of a transmission delay between the non-terrestrial node and the terminal.

The first time interval may be a minimum time interval required to allocate the downlink resource for the retransmission operation in the non-terrestrial network, and a length of the first time interval may be set to a multiple of the DRX cycle.

An ending time of the first time interval may be set to a starting time of the on-duration, an ending time of the on-duration, or an arbitrary time within the on-duration.

The first time interval may be a sum of a minimum time interval required to allocate the downlink resource for the retransmission operation in a terrestrial network and the transmission delay.

According to the exemplary embodiments of the present disclosure, in a non-terrestrial network, a communication node (e.g., non-terrestrial node, terminal) can perform a discontinuous reception (DRX) operation. In this case, parameters (e.g., timers) for a (re)transmission operation of data may be configured in consideration of a DRX cycle and/or a transmission latency in the non-terrestrial network. Therefore, the (re)transmission operation of data in the non-terrestrial network supporting the DRX operation can be efficiently performed, and power consumption at the terminal can be reduced.

### BRIEF DESCRIPTION OF DRAWINGS

Exemplary embodiments of the present disclosure will become more apparent by describing in detail embodiments of the present disclosure with reference to the accompanying drawings, in which:

FIG. 1 is a conceptual diagram illustrating a first exemplary embodiment of a communication network;

FIG. 2 is a block diagram illustrating a first embodiment of a communication node constituting a communication network;

FIG. 3 is a conceptual diagram illustrating a first exemplary embodiment of operation states of a terminal in a communication network;

FIG. 4 is a conceptual diagram illustrating a first exemplary embodiment of a non-terrestrial network;

FIG. 5 is a conceptual diagram illustrating a second exemplary embodiment of a non-terrestrial network;

FIG. 6 is a conceptual diagram illustrating a third exemplary embodiment of a non-terrestrial network;

FIG. 7 is a timing diagram illustrating a first exemplary embodiment of a discontinuous reception (DRX) operation in a terminal operating in an RRC connected state; and

FIG. 8 is a timing diagram illustrating a first exemplary embodiment of a DRX operation in a non-terrestrial network.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication network to which exemplary embodiments according to the present disclosure are applied will be described. The communication network may be a non-terrestrial network (NTN), a 4G communication network (e.g., a long-term evolution (LTE) communication network), a 5G communication network (e.g., a new radio (NR) communication network), or the like. The 4G communication network and the 5G communication network may be classified as terrestrial networks.

The non-terrestrial network may operate based on the LTE technology and/or the NR technology. The non-terrestrial network may support communication in a frequency band of 6 GHz or below, as well as a frequency band of 6 GHz or above. The 4G communication network may support communication in a frequency band of 6 GHz or below. The 5G communication network may support communication in a frequency band of 6 GHz or above, as well as the frequency band of 6 GHz or below. The communication network to which the exemplary embodiments according to the present disclosure are applied is not limited to the contents described below, and the exemplary embodiments according to the present disclosure may be applied to various communication networks. Here, the communication network may be used in the same sense as the communication system.

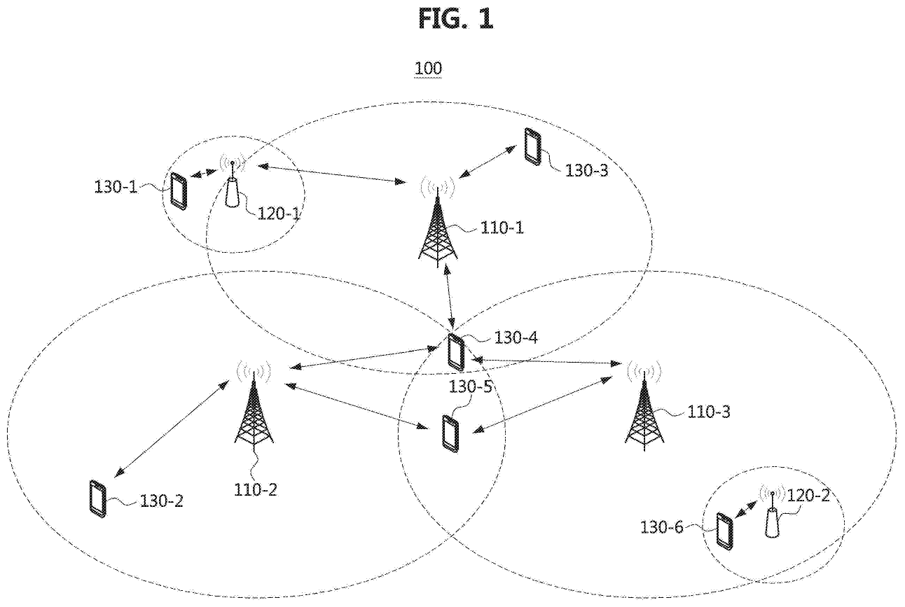

FIG. 1 is a conceptual diagram illustrating a first exemplary embodiment of a communication network.

Referring to FIG. 1, a communication network 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Also, the communication network 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication network 100 may have the following structure.

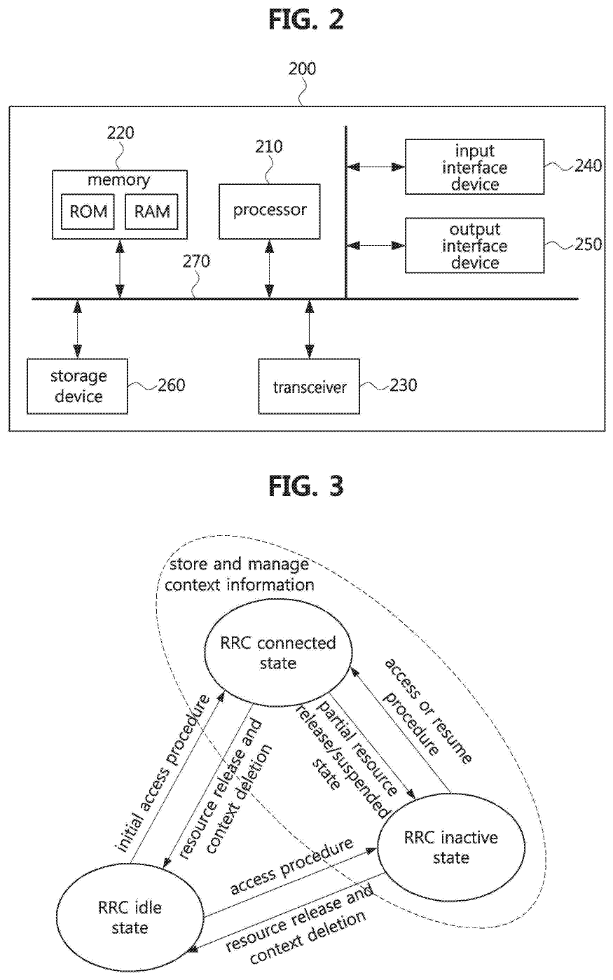

FIG. 2 is a block diagram illustrating a first embodiment of a communication node constituting a communication network.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication network 100 may comprise a plurality of base stations 110-1, 110-2, 110-3, 120-1, and 120-2, and a plurality of terminals 130-1, 130-2, 130-3, 130-4, 130-5, and 130-6. The communication network 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Also, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, transmission and reception methods and control methods in a communication network will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the exemplary embodiments below, the UPF (or, S-GW) may refer to a termination communication node of the core network that exchanges packets (e.g., control information, data) with the base station, and the AMF (or, MME) may refer to a communication node in the core network, which performs control functions in a radio access section (or, interface) of the terminal. Here, each of the S-GW, the MME, the AMF, and the UPF may be referred to as a different term according to a function (e.g., function of the core network) of a communication protocol depending on a radio access technology (RAT).

In a communication network supporting a dual connectivity function, connections may be established between a terminal and a plurality of base stations. The plurality of base stations may provide a service to the terminal. The plurality of base stations supporting the dual connectivity function (e.g., the plurality of base stations connected to the terminal) may be classified into a master base station and a secondary base station(s). In the exemplary embodiments below, the dual connectivity may mean a single-radio dual connectivity (SR-DC) by a plurality of base stations supporting the same radio access technology (RAT) or a multi-radio (MR)-DC by a plurality of base stations supporting different RATs.

The master base station may be referred to as a ‘master node’. The master node may be a node that mainly performs RRC functions in order to support the dual connectivity function. The master node may provide a control plane connection function with the core network. The master node may be composed of a plurality of cells. The plurality of cells included in the master node may be referred to as a master cell group (MCG). An MCG bearer may mean a bearer according to a logical channel configuration between an RLC layer and a MAC layer of a cell belonging to the MCG.

The secondary base station may be referred to as a ‘secondary node’. The secondary node may not provide a control plane connection function with the core network. The secondary node may provide a service to the terminal using additional radio resources. The secondary node may be composed of a plurality of cells. The plurality of cells included in the secondary node may be referred to as a secondary cell group (SCG). A split bearer may use a logical channel configuration between an RLC layer and a MAC layer of a cell belonging to the MCG, and a logical channel configuration between an RLC layer and a MAC layer of a cell belonging to the SCG. The split bearer may be classified into a secondary node (SN) terminated bearer and a master node (MN) terminated bearer according to a type of a node performing a PDCP function. When the PDCP function for the split bearer is performed at the master node, the split bearer may be an MN terminated bearer. When the PDCP function for the split bearer is performed at the secondary node, the split bearer may be an SN terminated bearer.

FIG. 3 is a conceptual diagram illustrating a first exemplary embodiment of operation states of a terminal in a communication network.

As shown in FIG. 3, operation states of the terminal may be classified into an RRC connected state, an RRC inactive state, and an RRC idle state. When the terminal operates in the RRC connected state or the RRC inactive state, a radio access network (RAN) (e.g., a control function block of the RAN) and the base station may store and manage RRC connection configuration information and/or context information (e.g., RRC context information, access stratum (AS) context information) of the corresponding terminal. In addition, the terminal operating in the RRC connected state or the RRC inactive state may store RRC connection configuration information and/or context information.

When the operation state of the terminal transitions from the RRC connected state to the RRC idle state or when the operation state of the terminal transitions from the RRC inactive state to the RRC idle state, the context information may be deleted in the RAN and the base station. The context information (e.g., RRC context information) may include an identifier assigned to the terminal, PDU session information, an encryption key, capability information, and the like.

The terminal operating in the RRC idle state may perform a cell selection operation or a cell reselection operation for camping on an optimal base station (e.g., optimal cell) by performing a monitoring operation (e.g., measurement operation) on downlink signals in an on-duration or an active time according to a discontinuous reception (DRX) cycle configured for low power consumption operations of the terminal. In order to camp on a new base station (e.g., new cell), the terminal may acquire system information from the base station. In addition, when system information required by the terminal exists, the corresponding terminal may request transmission of the system information. The terminal may perform a reception operation of a paging message in an on-duration or active time according to a paging occasion.

The terminal operating in the RRC connected state may configure a radio bearer (e.g., data radio bearer (DRB), signaling radio bearer (SRB)) with the base station (e.g., serving cell), and may store and manage context information (e.g., RRC context information) required in the RRC connected state. The terminal operating in the RRC connected state may perform a PDCCH monitoring operation by using the context information and the connection configuration information. The terminal may receive downlink data from the base station through radio resources indicated by DCI obtained by the PDCCH monitoring operation. In addition, the terminal may transmit uplink data to the base station using radio resources indicated by DCI obtained by the PDCCH monitoring operation.

The mobility function for the terminal operating in the RRC connected state may be supported through a handover procedure when the base station is changed. For the handover procedure, the terminal may perform a measurement operation on the base station and/or neighbor base station(s) (e.g., neighbor cell(s)) based on measurement and/or reporting parameters configured by the base station, and report the measurement results to the base station. In the exemplary embodiments below, the measurement operation may include an operation for reporting the measurement result. Also, the terminal operating in the RRC connected state may perform a DRX operation based on DRX parameters configured by the base station. For example, the terminal operating in the RRC connected state may perform the PDCCH monitoring operation in an on-duration or active time according to a DRX cycle.

The terminal operating in the RRC inactive state may store and manage context information required for the RRC inactive state. The terminal operating in the RRC inactive state or the RRC idle state may perform a DRX operation based on DRX parameters configured by the last base station (e.g., serving cell). For example, the terminal operating in the RRC inactive state may perform a monitoring operation or a measurement operation on downlink signals in an on-duration or active time according to a DRX cycle, and may perform a cell selection operation or a cell reselection operation based on the result of the monitoring operation or the measurement operation to camp on an optimal base station (e.g., optimal cell). The terminal may acquire system information for camping on a new base station (e.g., new cell), and may request transmission of system information (e.g., system information required by the terminal) when necessary. The terminal operating in the RRC inactive state or the RRC idle state may perform a reception operation of a paging message in an on-duration or active time according to a paging occasion.

A communication procedure between the base station and the terminal may be performed based on a beamforming scheme. In order to provide a mobility function between base stations or to select an optimal beam within the base station, a signal transmitted from the terminal may be used. Connections between the terminal and one or more base stations (e.g., one or more cells) may be configured, and one or more base stations may provide a service to the terminal. The configured connections between the terminal and one or more base stations may be maintained. For example, the one or more base stations may store and manage context information (e.g., AS context information). Alternatively, the terminal may be located in coverage of the base station without configuring a connection with the base station.

When a beamforming scheme is used in a high frequency band, in the communication system, a beam-level mobility function to change a configured beam of the terminal, a mobility function to change a configured beam between base stations (e.g., cells), a radio resource management function to change configuration of a radio link, and the like may be supported.

In order to perform the mobility support function and the radio resource management function, the base station may transmit a synchronization signal (e.g., a synchronization signal/physical broadcast channel (SS/PBCH) block) and/or a reference signal. In order to support multiple numerologies, frame formats supporting symbols having different lengths may be configured. In this case, the terminal may perform a monitoring operation of the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, a control channel (e.g., CORESET), a symbol, a slot, and/or a reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the base station may transmit a synchronization signal and/or a reference signal so that the terminal in its service area can search for itself to perform downlink synchronization maintenance, beam configuration, or link monitoring operations. Also, the terminal connected to the base station (e.g., serving base station) may receive physical layer radio resource configuration information for connection configuration and radio resource management from the base station. The physical layer radio resource configuration information may mean configuration parameters included in RRC control messages of the LTE communication system or the NR communication system. For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of a base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, a slot, and a subframe that exist within one radio frame (e.g., a frame of 10 ms) may be configured differently.
Configuration information of transmission frequency and frame format of base station
Transmission frequency configuration information: information on all transmission carriers (i.e., cell-specific transmission frequency) of the base station, information on BWPs in the base station, information on a transmission reference time or time difference between transmission frequencies of the base station (e.g., transmission periodicity or offset parameter indicating the transmission reference time (or time difference) of the synchronization signal), etc.
Frame format configuration information: configuration parameters of a mini-slot, slot, subframe that supports a plurality of symbol lengths according to SCS
Configuration information of downlink reference signal (e.g., channel state information-reference signal (CSI-RS), common reference signal (Common-RS), etc.)
Configuration parameters such as a transmission periodicity, a transmission position, a code sequence, or a masking (or scrambling) sequence for a reference signal commonly applied in the coverage of the base station (or beam).
Configuration information of uplink control signal
A sounding reference signal (SRS), reference signals for uplink beam sweeping (or beam monitoring), uplink grant-free radio resources (or, preamble), etc.
Configuration information of physical downlink control channel (e.g., PDCCH)
A reference signal for PDCCH demodulation, a beam common reference signal (e.g., a reference signal that can be received by all terminals in a beam coverage), a reference signal for beam sweeping (or beam monitoring), a reference signal for channel estimation, etc.
Configuration information of physical uplink control channel (e.g., PUCCH)
Configuration information of a scheduling request signal
Configuration information for a feedback (acknowledgement (ACK) or negative ACK (NACK)) transmission resource in a hybrid automatic repeat request (HARQ) procedure
Number of antenna ports, antenna array information, beam configuration and/or beam index mapping information for application of beamforming techniques
Configuration information of downlink and/or uplink signals (or uplink access channel resource) for beam sweeping (or beam monitoring)
Configuration information of parameters for a beam configuration operation, a beam recovery operation, a beam reconfiguration operation, a radio link re-establishment operation, a beam change operation within the same base station, a reception signal of a beam triggering handover execution to another base station, and timers controlling the above-described operations

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the following exemplary embodiments, ‘Resource-Config information’ may be a control message including one or more parameters among the radio resource configuration information of the physical layer. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group).

The configuration information included in the ‘Resource-Config information’ may be transmitted through one control message or different control messages according to the attributes of the configuration information. The beam index information may not express the index of the transmission beam and the index of the reception beam distinctly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station (e.g., serving cell). The terminal may perform a search operation or monitoring operation of a radio channel by using the synchronization signal (e.g., SS/PBCH block) and/or reference signal (e.g., CSI-RS) transmitted from the base station (e.g., serving cell). Here, the expression that a communication service is provided through a beam (e.g., configured beam) may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from the system information or the common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, the procedure for recovering a radio link, the procedure for detecting (or declaring) a radio link failure, and the procedure for re-establishing a radio link according to the RLM operation may be performed by functions of the layer 1 (e.g., physical layer), the layer 2 (e.g., MAC layer, RLC layer, PDCP layer, etc.), and/or the layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, a beam common reference signal, or a terminal (or terminal group) specific reference signal (e.g., a dedicated reference signal allocated to a terminal (or terminal group)). Here, the common reference signal may be used for channel estimation operations of all terminals located within a corresponding base station or beam coverage (or service area). The dedicated reference signal may be used for a channel estimation operation of a specific terminal or a specific terminal group located within a base station or beam coverage.

Accordingly, when the base station or the beam (e.g., the configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. In a handover procedure, a synchronization reconfiguration procedure, or a connection reconfiguration procedure, the base station may transmit a dedicated control message including the configuration information of the common reference signal to the terminal.

In this case, information for identifying the base station (e.g., cell) may be transferred to the terminal according to a configuration condition of the radio protocol of the base station. The information for identifying the base station may be delivered to the terminal by using a control message of the RRC layer, a control message of the MAC layer, or a physical layer control channel according to the layer(s) included in the base station. In the exemplary embodiments, the control message of the RRC layer may be referred to as an ‘RRC control message’ or ‘RRC message’, the control message of the MAC layer may be referred to as a ‘MAC control message’ or ‘MAC message’, and the physical layer control channel may be referred to as a ‘MY control channel’, ‘MY control message’, or ‘MY message’.

Here, the information for identifying the base station may include one or more among a base station identifier, reference signal information, reference symbol information, configured beam information, and configured TCI state information. The reference signal information (or reference symbol information) may include configuration information (e.g., radio resource, sequence, index) of a reference signal allocated to each base station, and/or configuration information (e.g., radio resource, sequence, index) of a dedicated reference signal allocated to the terminal.

Here, the radio resource information of the reference signal may include time domain resource information (e.g., frame index, subframe index, slot index, symbol index) and frequency domain resource information (e.g., a parameter indicating a relative or absolute position of subcarriers). The parameters indicating the radio resource of the reference signal may be a resource element (RE) index, a resource set index, a resource block (RB) index, a subcarrier index, a symbol index, or the like. The RB index may be a physical resource block (PRB) index or a common resource block (CRB) index.

In the following exemplary embodiments, the reference signal information may include transmission periodicity information, sequence information (e.g., code sequence), masking information (e.g., scrambling information), radio resource information, and/or index information of the reference signal. The reference signal identifier may mean a parameter (e.g., resource ID, resource set ID) used to identify each of a plurality of reference signal information. The reference signal information may refer to the configuration information of the reference signal.

The configured beam information may include one or more of a configured beam index (or identifier), a configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and a reference signal identifier. In the exemplary embodiments, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, a MAC message, and a PHY message, and may identify a base station with which the terminal performs a beam monitoring operation, a radio access operation, and/or a control (or data) packet transmission and reception operation.

When a plurality of beams are configured, communications between the base station and the terminal may be performed using the plurality of beams. In this case, the number of downlink beams may be the same as the number of uplink beams. Alternatively, the number of downlink beams may be different from the number of uplink beams. For example, the number of downlink beams may be two or more, and the number of uplink beams may be one.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more of scheduling information (e.g., radio resource allocation information, modulation and coding scheme (MCS) information), feedback information (e.g., channel quality indication (CQI), preceding matrix indicator (PMI), HARQ ACK, HARQ NACK), resource request information (e.g., scheduling request (SR)), a result of the beam monitoring operation for supporting beamforming functions, a TCI state ID, and measurement information for the active beam (or deactivated beam).

The radio resource information may include parameter(s) indicating frequency domain resources (e.g., center frequency, system bandwidth, PRB index, number of PBRs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The reference value indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to-noise ratio (SNR), a signal-to-interference ratio (SIR), a signal-to-noise and interference ratio (SINR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth.

The terminal operating in the RRC connected state may measure signal qualities of radio links of the serving cell and a measurement object cell (e.g., neighbor cell, target cell, candidate cell, etc.) based on the SS/PBCH block and/or the reference signal (e.g., CSI-RS). Here, the signal quality may be the RSRP, RSRQ, RSSI, SNR, SIR, SINR, and/or the like, which were described in the explanation for reception performance of the reference signals for the radio link or beam (e.g., TCI state) management.

The terminal operating in the RRC inactive state or the RRC idle state may measure a signal quality (e.g., RSRP, RSRQ, RSSI, SINR) of a radio link of the serving cell (e.g., cell on which the terminal is camped) or a measurement object cell according to a DRX cycle (e.g., measurement cycle) configured based on the SS/PBCH block. The terminal may perform a cell selection operation or a cell reselection operation based on the measurement result. For measurement of the serving cell (e.g., cell on which the cell is camped), the terminal may obtain a transmission periodicity (e.g., ssb-PeriodicityServingCell) of the SS/PBCH block or configuration information (e.g., ssb-PositionsInBurst) of a radio resource through which the SS/PBCH block is transmitted, from system information of the corresponding cell.

In addition, in order to measure the measurement object cell (e.g., neighbor cell), the terminal may obtain signal measurement time configuration (SMTC) window information from the system information. The terminal operating in the RRC inactive state or the RRC idle state may perform a cell selection operation or a cell reselection operation based on the measurement result of the SS/PBCH block. During the cell selection operation or the cell reselection operation, the terminal may recognize that a radio access network (RAN) area or a tracking area (TA) has been changed based on an identifier included in system information received from the cell. In this case, the terminal may perform an update procedure of the RAN area or TA.

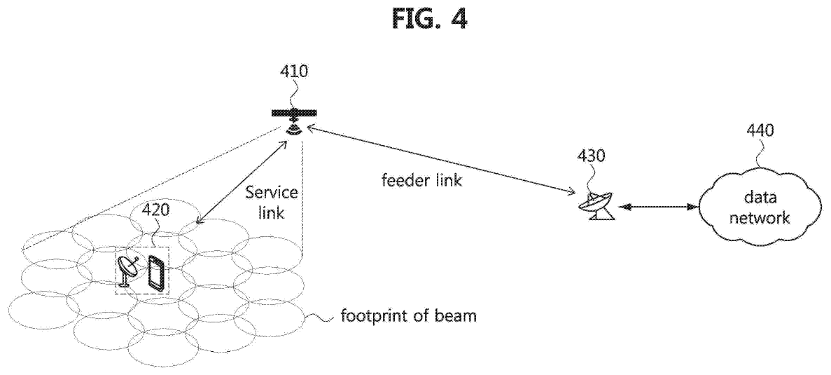

FIG. 4 is a conceptual diagram illustrating a first exemplary embodiment of a non-terrestrial network.

As shown in FIG. 4, a non-terrestrial network may include a satellite 410, a communication node 420, a gateway 430, a data network 440, and the like. The non-terrestrial network shown in FIG. 4 may be a transparent payload based non-terrestrial network. The satellite 410 may be a low earth orbit (LEO) satellite, a medium earth orbit (MEO) satellite, a geostationary earth orbit (GEO) satellite, a high elliptical orbit (HEO) satellite, or an unmanned aircraft system (UAS) platform. The UAS platform may include a high altitude platform station (HAPS). The satellite 410 may mean an unmanned aerial vehicle (UAV) or a UAV base station (UBS).

The communication node 420 may include a terrestrial communication node (e.g., user equipment (UE) or terminal) and a non-terrestrial communication node (e.g., airplane or drone). A service link may be established between the satellite 410 and the communication node 420, and the service link may be a radio link. The satellite 410 may provide a communication service to the communication node 420 by using one or more beams. A shape of a footprint of the beam of the satellite 410 may be elliptical. The satellite 410 may provide a communication service to a specific area. For example, the satellite 410 may provide a communication service to a specific area by using one beam. One area may exist for each cell, and multiple beams may be used in one cell.

The communication node 420 may perform communications (e.g., downlink communication and uplink communication) with the satellite 410 by using the LTE technology and/or the NR technology. The communication between the satellite 410 and the communication node 420 may be performed using an NR-Uu interface. When dual connectivity (DC) is supported, the communication node 420 may be connected to the satellite 410 as well as another base station (e.g., base station supporting LTE and/or NR functions), and may perform DC operations based on the technologies defined in the LTE and/or NR technical specification.

The gateway 430 may be located on the ground, and a feeder link may be established between the satellite 410 and the gateway 430. The feeder link may be a radio link. The gateway 430 may be referred to as a ‘non-terrestrial network (NTN) gateway’. The communication between the satellite 410 and the gateway 430 may be performed based on an NR-Uu interface or a satellite radio interface (SRI). The gateway 430 may be connected to the data network 440. A ‘core network’ may exist between the gateway 430 and the data network 440. In this case, the gateway 430 may be connected to the core network, and the core network may be connected to the data network 440. The core network may support the NR technology. For example, the core network may include an access and mobility management function (AMF), a user plane function (UPF), a session management function (SMF), and the like. The communication between the gateway 430 and the core network may be performed based on an NG-C/U interface.

Alternatively, the base station and the core network may exist between the gateway 430 and the data network 440. In this case, the gateway 430 may be connected to the base station, the base station may be connected to the core network, and the core network may be connected to the data network 440. The base station and the core network may support the NR technology. The communication between the gateway 430 and the base station may be performed based on an NR-Uu interface, and the communication between the base station and the core network (e.g., AMF, UPF, SMF) may be performed based on an NG-C/U interface.

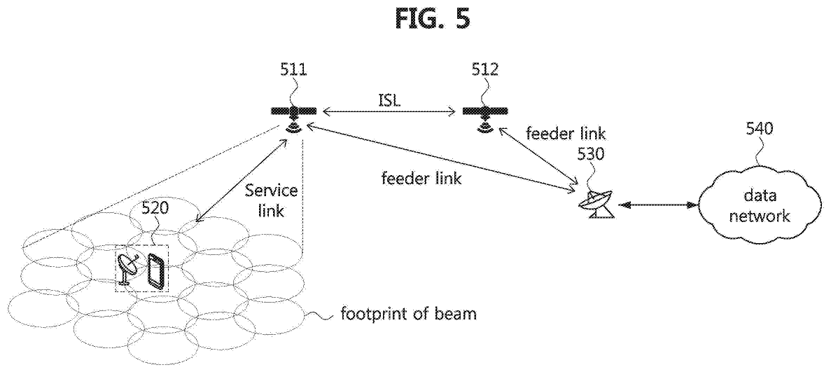

FIG. 5 is a conceptual diagram illustrating a second exemplary embodiment of a non-terrestrial network.

As shown in FIG. 5, a non-terrestrial network may include a satellite #1 511, a satellite #2 512, a communication node 520, a gateway 530, a data network 540, and the like. The non-terrestrial network shown in FIG. 5 may be a regenerative payload based non-terrestrial network. For example, each of the satellites 511 and 512 may perform a regeneration operation (e.g., demodulation operation, decoding operation, re-encoding operation, re-modulation operation, and/or filtering operation) on a payload received from another entity (e.g., communication node 520, gateway 530) constituting the non-terrestrial network, and transmit the regenerated payload.

Each of the satellites 511 and 512 may be a LEO satellite, MEO satellite, GEO satellite, HEO satellite, or UAS platform. The UAS platform may include an HAPS. Each of the satellites 511 and 512 may mean a UAV or UBS. The satellite 511 may be connected to the satellite 512, and an inter-satellite link (ISL) may be established between the satellite 511 and the satellite 512. The ISL may operate in a radio frequency (RF) band or optical band. The ISL may be configured optionally. The communication node 520 may include a terrestrial communication node (e.g., UE, terminal) and a non-terrestrial communication node (e.g., airplane, drone). A service link (e.g., radio link) may be established between the satellite 511 and the communication node 520. The satellite 511 may provide a communication service to the communication node 520 by using one or more beams.

The communication node 520 may perform communication (e.g., downlink communication and uplink communication) with the satellite 511 using the LTE technology and/or the NR technology. The communication between the satellite 511 and the communication node 520 may be performed using an NR-Uu interface. When DC is supported, the communication node 520 may be connected to the satellite 511 as well as another base station (e.g., base station supporting the LTE and/or NR functions), and may perform DC operations based on the technologies defined in the LTE and/or NR technical specification.

The gateway 530 may be located on the ground, and a feeder link may be established between the satellite 511 and the gateway 530, and a feeder link may be established between the satellite 512 and the gateway 530. The feeder link may be a radio link. When an ISL is not established between the satellite 511 and the satellite 512, the feeder link between the satellite 511 and the gateway 530 may be established mandatorily.

The communication between each of the satellites 511 and 512 and the gateway 530 may be performed based on an NR-Uu interface or an SRI. The gateway 530 may be connected to the data network 540. A ‘core network’ may exist between the gateway 530 and the data network 540. In this case, the gateway 530 may be connected to the core network, and the core network may be connected to the data network 540. The core network may support the NR technology. For example, the core network may include an AMF, a UPF, an SMF, and the like. The communication between the gateway 530 and the core network may be performed based on an NG-C/U interface.

Alternatively, the base station and the core network may exist between the gateway 530 and the data network 540. In this case, the gateway 530 may be connected to the base station, the base station may be connected to the core network, and the core network may be connected to the data network 540. The base station and the core network may support the NR technology. The communication between the gateway 530 and the base station may be performed based on an NR-Uu interface, and the communication between the base station and the core network (e.g., AMF, UPF, SMF) may be performed based on an NG-C/U interface.

Meanwhile, scenarios in the non-terrestrial network may be defined as Table 1 below.

TABLE 1

| | NTN shown in | NTN shown in |
|---|---|---|
| | FIG. 4 | FIG. 5 |
| GEO | Scenario A | Scenario B |
| LEO (steerable beams) | Scenario C1 | Scenario D1 |
| LEO (beams moving with | Scenario C2 | Scenario D2 |
| the satellite) | | |

In the non-terrestrial network shown in FIG. 4, when the satellite 410 is a GEO satellite (e.g., a GEO satellite supporting a transparent function), it may be referred to as a ‘scenario A’. In the non-terrestrial network shown in FIG. 5, when the satellite 511 and 512 are GEO satellites (e.g., GEO satellites supporting regenerative functions), it may be referred to as a ‘scenario B’.

In the non-terrestrial network shown in FIG. 4, when the satellite 410 is a LEO satellite having steerable beams, it may be referred to as a ‘scenario C1’. In the non-terrestrial network shown in FIG. 4, when the satellite 410 is a LEO satellite having beams moving with the satellite, it may be referred to as a ‘scenario C2’. In the non-terrestrial network shown in FIG. 5, when the satellites 511 and 512 are LEO satellites having steerable beams, it may be referred to as a ‘scenario D1’. In the non-terrestrial network shown in FIG. 5, when the satellites 511 and 512 are LEO satellites having beams moving with the satellites, it may be referred to as a ‘scenario D2’.

Parameters for the scenarios defined in Table 1 may be defined as Table 2 below.

TABLE 2

| | Scenarios A and B | | Scenarios C and D |
|---|---|---|---|
| Altitude | 35,786 | km | 600 km |
| | | | 1,200 km |
| Spectrum (service link) | <6 GHz (e.g., 2 GHz) | | |
| | >6 GHz (e.g., DL: 20 GHz, | | |
| | UL: 30 GHz) | | |
| Maximum channel | 30 MHz for band < 6 GHz | | |
| bandwidth capability | 1 GHz for band > 6 GHz | | |
| (service link) | | | |
| Maximum distance between | 40,581 | km | 1,932 km (600 km altitude) |
| satellite and communication | | | 3,131 km (1,200 km altitude) |
| node (e.g., UE) at minimum | | | |
| elevation angle | | | |
| Maximum round trip delay | Scenario A: 541.46 ms | | Scenario C (transparent |
| (RTD) (propagation delay | (service and feeder links) | | payload: service and feeder |
| only) | Scenario B: 270.73 ms | | links) |
| | (service link only) | | 25.77 ms (600 km altitude) |
| | | | 41.77 ms (1,200 km altitude) |
| | | | Scenario D (regenerative |
| | | | payload: service link only) |
| | | | 12.89 ms (600 km altitude) |
| | | | 20.89 ms (1,200 km altitude) |
| Maximum variance of delay | 16 | ms | 4.44 ms (600 km altitude) |
| within a cell | | | 6.44 ms (1,200 km altitude) |
| Maximum differential delay | 10.3 | ms | 3.12 ms (600 km altitude) |
| within a cell | | | 3.18 ms (1,200 km altitude) |

| | |
|---|---|
| Service link | 3GPP defined NR |
| Feeder link | 3GPP or non-3GPP defined radio interface |

In addition, in the scenarios defined in Table 1, a delay constraint may be defined as shown in Table 3 below.

TABLE 3

| | | | Scenario | | Scenario | |
|---|---|---|---|---|---|---|
| | Scenario A | Scenario B | C1-2 | | D1-2 | |
| Satellite | 35,786 km | | 600 km | | | |
| altitude | | | | | | |
| Maximum | 541.75 ms | 270.57 ms | 28.41 | ms | 12.88 | ms |
| RTD in a radio | (worst case) | | | | | |
| interface | | | | | | |
| between base | | | | | | |
| station and UE | | | | | | |
| Minimum RTD | 477.14 ms | 238.57 ms | 8 | ms | 4 | ms |
| in a radio | | | | | | |
| interface | | | | | | |
| between base | | | | | | |
| station and UE | | | | | | |

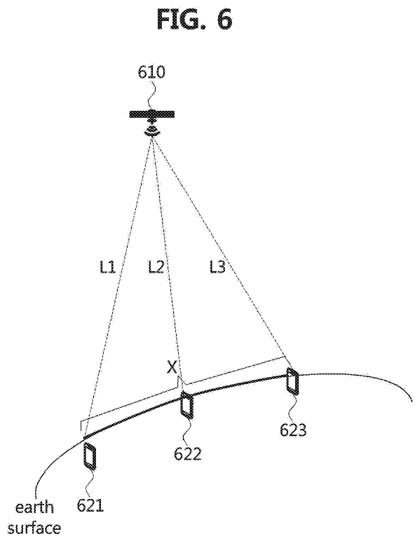

FIG. 6 is a conceptual diagram illustrating a third exemplary embodiment of a non-terrestrial network.

As shown in FIG. 6, a non-terrestrial network may include a non-terrestrial node 610, a terminal #1 621, a terminal #2 622, and a terminal #3 623. The non-terrestrial node 610 may mean a satellite, HAPS, UAV, or UBS. For example, the non-terrestrial node 610 may be a satellite located at 600 km to 35,000 km from the earth surface. Alternatively, the non-terrestrial node 610 may be a HAPS, UAV, or UBS located at 10 km to 600 km from the earth surface. The non-terrestrial node 610 may perform a function of a base station or a relay in a terrestrial network (e.g., LTE communication network or NR communication network). The maximum length of the service area of the non-terrestrial node 610 on the earth surface (e.g., the diameter of the service area when the shape of the service area is circular) may be 500 km. In FIG. 6, X may be the maximum length of the service area of the non-terrestrial node 610.

When the non-terrestrial node 610 is a high-altitude geostationary satellite (e.g., GEO satellite), a transmission delay of 280 ms may occur in radio sections L1 to L3 between the non-terrestrial node 610 and the terminals 621 to 623. The transmission delay may be a round trip delay (RTD) or a propagation delay (RTD) in the radio sections L1 to L3. A difference Ldelay_diff between the transmission delay in the radio section L2 between the non-terrestrial node 610 and the closest terminal 622 and the transmission delay in the radio section L1 or L3 between the non-terrestrial node 610 and the farthest terminal 621 or 623 may be about 2 ms.

Each of the transmission delay and Ldelay_diff between the non-terrestrial node 610 and the terminals 621 to 623 may be much larger than a transmission delay and Ldelay_diff in a terrestrial network. Therefore, in the non-terrestrial network, each of a control signaling operation, a downlink monitoring operation, a downlink reception operation, and an uplink transmission operation may be performed in consideration of the transmission delay and/or Ldelay_diff.

In the OFDMA-based communication network, in order for a base station to receive uplink signals of a plurality of terminals without interference, uplink signals transmitted from the plurality of terminals should be aligned in the time domain. Here, the uplink signal may mean a signal including an uplink channel and/or signal. To support this operation, the base station may adjust timing of uplink transmission(s) by transmitting timing advance (TA) information to the terminal(s). In order to adjust the timing of uplink transmissions between the non-terrestrial nodes 610 and the terminals 621 to 623 in the non-terrestrial network, a control signaling operation for transmitting the TA information may be performed. However, in the corresponding control signaling operation, transmission delays in the radio sections L1 to L3 should be considered.

To support this operation, the non-terrestrial node 610 may transmit information on the transmission delays in the radio sections L1 to L3 to the corresponding terminals 621 to 623. Here, the information on the transmission delays may be information on the minimum transmission delay (hereinafter, referred to as ‘Ldelay_min information’) in the radio section L2 between the non-terrestrial node 610 and the closest terminal 622. That is, the Ldelay_min information may be transmitted from the non-terrestrial node 610 to the terminals 621 to 623. The Ldelay_min information (e.g., the minimum transmission delay) may be configured in units of a symbol, a mini-slot, a slot, a subframe, or a radio frame. Alternatively, the Ldelay_min information may be configured in absolute time units (e.g., ms, sec). The non-terrestrial node 610 may transfer not the minimum transmission delay value (e.g., Ldelay_min) but a value (e.g., Ldelay_ref) representing the transmission delay of the radio sections L1 to L3 to the terminals 621 to 623. In this case, Ldelay_min in the following exemplary embodiments may be replaced with Ldelay_ref. That is, Ldelay_min may mean Ldelay_ref.

Before receiving TA information from the non-terrestrial node 610 (e.g., when a random access procedure is not completed or when uplink synchronization is not acquired), the terminals 621 to 623 may obtain uplink synchronization information from system information. Alternatively, each of the terminals 621 to 623 may adjust uplink transmission timing by using the Ldelay_min (or Ldelay_ref) estimated or calculated by the terminal itself. In the exemplary embodiments, the uplink synchronization may mean uplink physical layer synchronization, and the uplink transmission timing may mean uplink physical layer transmission timing. Thereafter, each of the terminals 621 to 623 may adjust timing of the uplink transmission by using the TA information received from the non-terrestrial node 610.

The TA information transmitted by the non-terrestrial node 610 may be adjustment information of uplink transmission timing in consideration of Ldelay_min (or Ldelay_ref). For example, when an uplink transmission timing value to be adjusted by one of the terminals 621 to 623 is 10 and Ldelay_min (or Ldelay_ref) is 8, the non-terrestrial node 610 may transmit, to the one of the terminals 621 to 623, TA information instructing to adjust the uplink transmission timing by 2.

The terminals 621 to 623 may adjust the uplink transmission timing based on the Ldelay_min and/or TA information received from the non-terrestrial node 610. A parameter for managing the uplink transmission timing may be configured with ‘timeAlignmentTimer’ When a message including the TA information (e.g., a MAC message or a random access (RA) response message) is received from the non-terrestrial node 610, the terminal may (re)start the timeAlignmentTimer. When the message including the TA information is not received until the timeAlignmentTimer expires, the terminals 621 to 623 may determine that the uplink synchronization has failed to be maintained. In this case, the terminals 621 to 623 may perform a synchronization acquisition procedure (e.g., RA procedure) for uplink transmission.

Ldelay_min (or Ldelay_ref) information may be configured differently according to the type, altitude, etc. of the non-terrestrial node 610. The non-terrestrial node 610 may transmit system information or another control message (e.g., MAC control message or PHY control message) including the Ldelay_min (or Ldelay_ref) information to the terminals 621 to 623. That is, the Ldelay_min (or Ldelay_ref) information may be signaled in an explicit manner through system information. Alternatively, the terminals 621 to 623 may estimate or calculate Ldelay_min (or Ldelay_ref) in an implicit manner. For example, the non-terrestrial node 610 may transmit system information including its type information, altitude information, etc. to the terminals 621 to 623. The terminals 621 to 623 may receive the system information from the non-terrestrial node 610, and estimate or calculate Ldelay_min (or, Ldelay_ref) based on the information (e.g., type information and altitude information of the non-terrestrial node 610) included in the system information. The type information of the non-terrestrial node 610 may indicate the type of the non-terrestrial node 610 as a satellite, HAPS, UAV, or UBS.

Each of the terminals 621 to 623 may determine the type of the non-terrestrial node 610 as a GEO satellite, a non-GEO satellite (e.g., LEO satellite, MEO satellite, or HEO satellite), a HAPS, a UAV, or a UBS based on the configuration information (e.g., type information, altitude information, etc.) of the non-terrestrial node 610. Information used to identify the non-terrestrial node 610 may be transmitted from the non-terrestrial node 610 to the terminals 621 to 623 through system information and/or a control message. The altitude information of the non-terrestrial node 610 may be information indicating an actual altitude of the non-terrestrial node 610 or information indicating an altitude classification (e.g., low altitude, medium altitude, high altitude) to which the actual altitude of the non-terrestrial node 610 belongs. The altitude information of the non-terrestrial node 610 may be transmitted from the non-terrestrial node 610 to the terminals 621 to 623 through system information and/or a control message. The terminals 621 to 623 may estimate or calculate Ldelay_min (or Ldelay_ref) based on the configuration information (e.g., type information, altitude information) received from the non-terrestrial node 610.

Alternatively, the terminals 621 to 623 may estimate or calculate Ldealy_min (or, Ldelay_ref) by using an identifier (e.g., an identifier for identifying a cell (e.g., physical cell identifier (PCI)) or an identifier for identifying a beam) of the non-terrestrial node 610. The PCI may be configured differently depending on the type and/or altitude of the non-terrestrial node 610. Accordingly, the terminals 621 to 623 may identify the type and/or altitude of the non-terrestrial node 610 based on the PCI received from the non-terrestrial node 610, and estimate or calculate Ldelay_min based on the identified information. That is, the terminals 621 to 623 may estimate or calculate Ldelay_min using the configuration information and/or identifier of the non-terrestrial node 610. The non-terrestrial node 610 may provide communication services to the terminals 621 to 623 using a plurality of beams or a plurality of frequency resources. In this case, Ldelay_min of non-terrestrial nodes located at the same altitude or non-terrestrial nodes of the same type may have the same value.

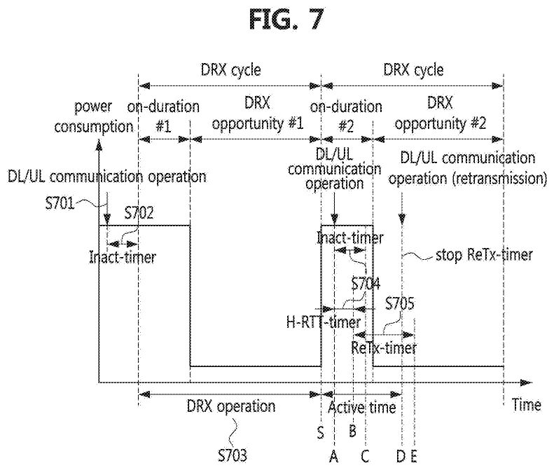

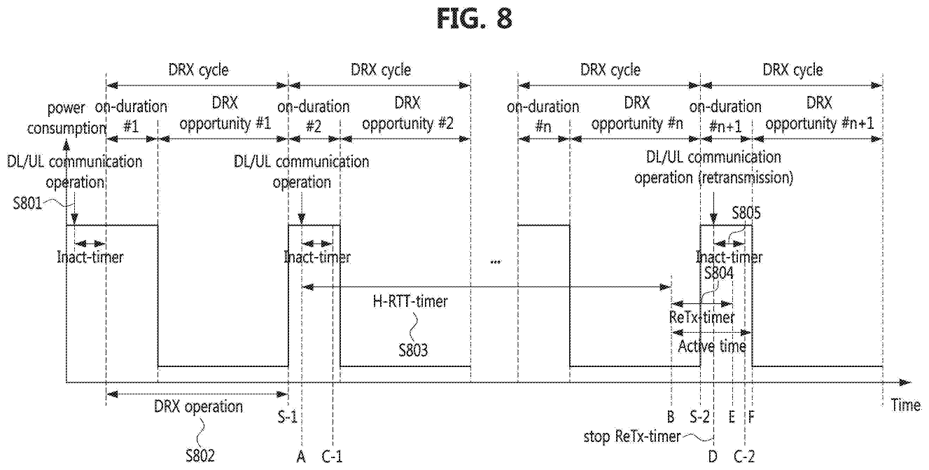

FIG. 7 is a timing diagram illustrating a first exemplary embodiment of a discontinuous reception (DRX) operation in a terminal operating in an RRC connected state.

Referring to FIG. 7, a terminal may be connected to a non-terrestrial node or a terrestrial node (e.g., base station), and may operate in an RRC connected state. In exemplary embodiments, the non-terrestrial node may mean a satellite, HAPS, UAV, or UBS. Further, the non-terrestrial node may refer to a base station installed in the non-terrestrial node, a cell formed by the non-terrestrial node, and the like. Each of the non-terrestrial node, base station, and cell logically connected to the terminal may mean a serving non-terrestrial node, a serving base station, and a serving cell. The non-terrestrial node may provide communication services to the terminal. The terminal operating in the RRC connected state may perform a DRX operation to reduce power consumption.

The non-terrestrial node may transmit DCI including downlink scheduling information (e.g., information indicating downlink reception) or uplink scheduling information (e.g., information indicating uplink transmission) to the terminal on a control channel (e.g., PDCCH) (S701). The terminal operating in the RRC connected state may receive the DCI from the non-terrestrial node by performing a monitoring operation on the control channel.

Alternatively, the non-terrestrial node may transmit downlink data to the terminal using a preconfigured resource (e.g., periodic resource) (S701). The terminal may receive the downlink data from the non-terrestrial node by performing a monitoring operation on the preconfigured resource. Alternatively, the terminal may transmit uplink data to the non-terrestrial node using a preconfigured resource (e.g., periodic resource) (S701). The non-terrestrial node may receive the uplink data from the terminal by performing a monitoring operation on the preconfigured resource. Here, the preconfigured resource may be a resource configured according to a semi-persistent scheduling (SPS) scheme or a configured grant (CG) scheme.

In exemplary embodiments, the step S701 may be referred to as a ‘DL/UL communication operation’, and the DL/UL communication operation may include a transmission operation of DCI (e.g., DCI including downlink scheduling information or uplink scheduling information) using a PDCCH, a transmission operation of downlink data using a preconfigured resource, or a transmission operation of uplink data using a preconfigured resource. The transmission operation of downlink data using a preconfigured resource may include a transmission and reception operation of an indicator requesting activation of the preconfigured resource (e.g., SPS resource). The transmission operation of uplink data using a preconfigured resource may include a transmission and reception operation of an indicator requesting activation of the preconfigured resource (e.g., CG resource).

The terminal may (re)start an inactivity timer for the DRX operation at the time (e.g., starting time or ending time) of DL/UL communication operation (S702). The time of the DL/UL communication operation may be a starting time of receiving the DCI, an ending time of receiving the DCI, a starting time of receiving the downlink data, an ending time of receiving the downlink data, a starting time of transmitting the uplink data, or an ending time of transmitting the uplink data. In the exemplary embodiments, the inactivity timer may be referred to as an ‘Inact-timer’. If another DL/UL communication operation is not performed until the Inact-timer expires, the terminal may perform the DRX operation according to a preconfigured DRX cycle (S703). The DRX cycle may include an on-duration and an opportunity for DRX. The terminal may perform a downlink monitoring operation in the on-duration, and may not perform a downlink monitoring operation in the opportunity for DRX. In the exemplary embodiments, the opportunity for DRX may be referred to as a ‘sleep period’. The terminal may operate in a sleep state in the sleep period.

The terminal operating in the RRC connected state may perform the DRX operation.

In this case, the terminal may repeatedly perform an operation (e.g., downlink monitoring operation) in the on-duration and an operation (e.g., sleep operation) in the sleep period according to the DRX cycle. The terminal may set a timer for the on-duration (hereinafter referred to as an ‘on-duration timer’), and (re)start the on-duration timer at the starting time of the on-duration. The terminal may determine the expiration time of the on-duration timer as the ending time of the on-duration.

When a DL/UL communication operation is performed in an on-duration #2 (e.g., point ‘A’ in the on-duration #2), the terminal may (re)start the Inact-timer and an H-RTT-timer (S704). The H-RTT-timer may be set for each downlink HARQ process or uplink HARQ process. For example, the H-RTT-timer may be independently configured for each HARQ process identifier (ID) or HARQ process number. In downlink communication, the H-RTT-timer may be defined as ‘drx-HARQ-RTT-TimerDL’, and in uplink communication, the H-RTT-timer may be defined as ‘drx-HARQ-RTT-TimerUL’. In the exemplary embodiments, the drx-HARQ-RTT-TimerDL may be referred to as ‘H-RTT-TimerDL’, and the drx-HARQ-RTT-TimerUL may be referred to as ‘H-RTT-TimerUL’.

The H-RTT-TimerDL may indicate the minimum time required to allocate downlink resources for HARQ retransmission. The H-RTT-TimerUL may indicate the minimum time required to allocate uplink resources for HARQ retransmission. The H-RTT-TimerDL and H-RTT-TimerUL may be (re)started in case (s) below.
Case 1: When a PDCCH (e.g., DCI transmitted on the PDCCH) indicates execution of a downlink reception operation or an uplink transmission operation
Case 2: When downlink data or uplink data is transmitted/received in a preconfigured resource (e.g., SPS resource or CG resource)

At the expiration time (e.g., point ‘B’) of the H-RTT-TimerDL or the H-RTT-TimerUL, the terminal may (re)start an ReTx-timer (S705). When the DL/UL communication operation fails in the on-duration, the ReTx-timer may be (re)started for the DL/UL communication operation for retransmission. For example, when an acknowledgment (ACK) for data is not received in a time interval according to the H-RTT-timer or when a negative ACK (NACK) for data is received in a time interval according to the H-RTT-timer, the terminal may (re)start the ReTx-timer.

The ReTx-timer may be set for each downlink HARQ process or uplink HARQ process. For example, the ReTx-timer may be independently configured for each HARQ process ID or HARQ process number. In downlink communication, the ReTx-timer may be defined as ‘drx-RetransmissionTimerDL’, and in uplink communication, the ReTx-timer may be defined as ‘drx-RetransmissionTimerUL’. In exemplary embodiments, the drx-RetransmissionTimerDL may be referred to as ‘ReTx-TimerDL’, and the drx-RetransmissionTimerUL may be referred to as ‘ReTx-TimerUL’.

The ReTx-TimerDL may be a timer indicating a valid monitoring interval for a control channel (e.g., PDCCH) indicating allocation of a downlink resource for HARQ retransmission or activation of a downlink resource (e.g., SPS resource). The ReTx-TimerUL may be a timer indicating a valid monitoring interval for a control channel (e.g., PDCCH) indicating allocation of an uplink resource for HARQ retransmission or activation of an uplink resource (e.g., CG resource). The ReTx-TimerDL may be (re)started when the H-RTT-TimerDL expires, and the ReTx-TimerUL may be (re)started when the H-RTT-TimerUL expires. Each of the ReTx-TimerDL and ReTx-TimerUL may be stopped in case(s) below.
Case 1: When a PDCCH (e.g., DCI transmitted on the PDCCH) indicates execution of a downlink reception operation or an uplink transmission operation
Case 2: When a downlink communication operation or an uplink communication operation is performed on a preconfigured resource (e.g., SPS resource or CG resource)

For example, when a DL/UL communication operation (e.g., DL/UL communication operation for retransmission) is performed in a time interval (e.g., point ‘D’) according to the ReTx-TimerDL or the ReTx-TimerUL, the terminal may stop the ReTx-TimerDL or the ReTx-TimerUL That is, when the DL/UL communication operation is performed before the expiration time (e.g., point ‘E’) of the ReTx-TimerDL or the ReTx-TimerUL, the terminal may stop the ReTx-TimerDL or the ReTx-TimerUL at the time (e.g., point ‘D’) of performing the DL/UL communication operation. In this case, a time interval from the starting time (e.g., point ‘S’) of the on-duration #2 to the stopping time (e.g., point ‘D’) of the ReTx-TimerDL or ReTx-TimerUL may be defined as an ‘active time’.

When the DL/UL communication operation fails in the on-duration #2, a DL/UL communication operation for retransmission may be performed after the on-duration #2 ends. In this case, the terminal may perform a downlink monitoring operation during the active time from the starting time (e.g., point ‘S’) of the on-duration #2 to the ending time (e.g., point ‘D’) of the DL/UL communication operation for retransmission. When the Inact-timer expires or when the active time ends (e.g., an active time-related timer expires), the terminal may perform the DRX operation according to a preconfigured DRX cycle or DRX parameter(s).

In the above-described DRX operation or the DRX operation to be described later, the non-terrestrial node may set the timers (e.g., Inact-timer, H-RTT-timer, ReTx-Timer), and may inform the terminal of the set timers by using a combination of at least one of an RRC message, a MAC message, and/or a PHY message. For example, before the step S701 (or before the step S801), the non-terrestrial node may transmit an RRC message, MAC message, and/or PHY message including information of the timers (e.g., Inact-timer, H-RTT-timer, ReTx-Timer) to the terminal. The terminal may identify the timers (e.g., Inact-timer, H-RTT-timer, ReTx-timer) by receiving the RRC message, MAC message, and/or PHY message from the non-terrestrial node, and may perform the DRX operations by using the identified timer(s).

Meanwhile, in the DRX operation shown in FIG. 7, a transmission delay parameter (hereinafter referred to as ‘Ldelay_value’) may be considered in a radio section between the non-terrestrial node and the terminal in the non-terrestrial network shown in FIG. 6. The Ldelay_value may be the Ldelay_min (or, Ldelay_ref), a transmission delay in a radio section, which is estimated or calculated by the non-terrestrial node, or a transmission delay in a radio section, which is estimated (or, measured) or calculated by the terminal.

FIG. 8 is a timing diagram illustrating a first exemplary embodiment of a DRX operation in a non-terrestrial network.

Referring to FIG. 8, a terminal may be connected to a non-terrestrial node, and may operate in the RRC connected state. In exemplary embodiments, the non-terrestrial node may mean a satellite, HAPS, UAV, or UBS. Further, the non-terrestrial node may refer to a base station installed in the non-terrestrial node, a cell formed by the non-terrestrial node, and the like. Each of the non-terrestrial node, base station, and cell logically connected to the terminal may mean a serving non-terrestrial node, a serving base station, and a serving cell. The non-terrestrial node may provide communication services to the terminal. The terminal operating in the RRC connected state may perform a DRX operation to reduce power consumption.

The H-RTT-timer (hereinafter referred to as ‘non-terrestrial H-RTT-timer’) used in the non-terrestrial network may be set in consideration of Ldelay_value. The H-RTT-timer used in the terrestrial network (e.g., 4G communication network or 5G communication network) may be referred to as ‘terrestrial H-RTT-timer’. For example, the H-RTT-timer shown in FIG. 7 may be the terrestrial H-RTT-timer. The non-terrestrial H-RTT-timer (e.g., non-terrestrial H-RTT-TimerDL, non-terrestrial H-RTT-TimerUL) may be set to a value greater than Ldelay_value or Ldelay_value. Alternatively, the non-terrestrial H-RTT-timer may be set based on a sum of the terrestrial H-RTT-timer and Ldelay_value. Alternatively, the non-terrestrial H-RTT-timer may be set by considering a transmission delay deviation (e.g., Ldelay_diff) between the non-terrestrial node and a plurality of terminals, in addition to the sum of the terrestrial H-RTT-timer and Ldelay_value. For example, the non-terrestrial H-RTT-timer may be set based on Equation 1 or Equation 2 below.

Non-terrestrial H-RTT-TimerDL=terrestrial H-RTT-TimerDL+Ldelay_value

Non-terrestrial H-RTT-TimerUL=terrestrial H-RTT-TimerUL+Ldelay_value [Equation 1]

Non-terrestrial H-RTT-TimerDL=terrestrial H-RTT-TimerDL+Ldelay_value±Ldelay_diff

Non-terrestrial H-RTT-TimerUL=terrestrial H-RTT-TimerUL+Ldelay_value±Ldelay_diff [Equation 2]

The non-terrestrial H-RTT-timer may be configured by the non-terrestrial node. The non-terrestrial node may inform the terminal of the non-terrestrial H-RTT-timer through a combination of at least one of an RRC message, a MAC message, and a PHY message. The terminal may identify the non-terrestrial H-RTT-timer by receiving the RRC message, the MAC message, and/or the PHY message from the non-terrestrial node. Alternatively, the non-terrestrial H-RTT-timer may be set by the terminal. For example, the terminal may determine the non-terrestrial H-RTT-timer based on Equation 1. The terrestrial H-RTT-timer and/or Ldelay_value may be signaled from the non-terrestrial node to the terminal. Alternatively, the terrestrial H-RTT-timer may be determined by the terminal, and the Ldelay_value may be a value measured (e.g., estimated) or calculated by the terminal.

For efficiency of the DRX operation in the non-terrestrial network, the non-terrestrial H-RTT-timer (e.g., non-terrestrial H-RTT-TimerDL, non-terrestrial H-RTT-TimerUL) may be set to a multiple of the DRX cycle (or, on-duration, DRX opportunity). The non-terrestrial H-RTT-timer may be set such that the ending time of the time interval according to the non-terrestrial H-RTT-timer is located within the on-duration according to the DRX cycle. Alternatively, the non-terrestrial H-RTT-timer may be set such that the ending time of the time interval according to the non-terrestrial H-RTT-timer is aligned with the starting or ending time of the on-duration according to the DRX cycle.

The non-terrestrial node may transmit DCI including downlink scheduling information (e.g., information indicating downlink reception) or uplink scheduling information (e.g., information indicating uplink transmission) to the terminal on a control channel (e.g., PDCCH) (S801). The terminal operating in the RRC connected state may receive the DCI from the non-terrestrial node by performing a monitoring operation on the control channel. When another DL/UL communication operation is not performed in a time interval from the completion time of the downlink communication operation or the uplink communication operation indicated by the DCI to the ending time of the Inact-timer, the terminal may perform a DRX operation according to a preconfigured DRX cycle (S802). In this case, the terminal may perform a downlink monitoring operation in the on-duration #1, and may not perform the downlink monitoring operation in a DRX opportunity #1 (e.g., sleep period #1). For example, the terminal may operate in the sleep state in the sleep period #1.

Meanwhile, when a DL/UL communication operation is performed in the on-duration #2 (e.g., point ‘A’ within the on-duration #2), the terminal may (re)start the Inact-timer and the H-RTT-timer (S803). The H-RTT-timer may be set for each downlink HARQ process or uplink HARQ process. For example, the H-RTT-timer may be independently configured for each HARQ process ID or HARQ process number. The H-RTT-Timer may indicate the minimum time required to allocate resources for HARQ retransmission in the non-terrestrial network. The H-RTT-Timer may be started when a PDCCH (e.g., DCI transmitted on the PDCCH) indicates execution of a downlink reception operation or an uplink transmission operation, or when uplink data or downlink data is transmitted and received in a preconfigured resource (e.g., SPS resource or CG resource).

When the on-duration #2 ends without performing another DL/UL communication operation in a time interval from the point ‘A’ to the ending time of the Inact-timer, the terminal may perform a DRX based on a preconfigured DRX cycle and DRX parameter(s). Here, the DRX operation may be performed in a time interval according to the H-RTT-timer. The terminal may (re)start the ReTx-timer at the ending time of the H-RTT-timer (S804). When the DL/UL communication operation fails in the on-duration #2, the ReTx-timer may be (re)started for a DL/UL communication operation for retransmission. For example, when ACK for data is not received in the time interval according to the H-RTT-timer or when NACK for the data is received in the time interval according to the H-RTT-timer, the terminal may (re)start the ReTx-timer.

The terminal may perform a downlink monitoring operation in the interval according to the ReTx-timer. The ReTx-timer may be set for each downlink HARQ process or uplink HARQ process in the non-terrestrial network. For example, the ReTx-timer may be independently configured for each HARQ process ID or HARQ process number.

When the ending time of the H-RTT-timer is located in a sleep period #n before an on-duration #n+1, the terminal may perform a downlink monitoring operation from the point B withing the sleep period #n before the starting time (e.g., point ‘S−2’) of the on-duration #n+1. Here, n may be an integer of 3 or more. The terminal may determine that a DL/UL communication operation for retransmission occurs by performing the downlink monitoring operation. The DL/UL communication operation for retransmission may be a retransmission operation for DL/UL communication operation that failed in the on-duration #2. In this case, the terminal may (re)start the Inact-timer at the time (e.g., point D) of occurrence of the DL/UL communication operation for retransmission (S805). In addition, the terminal may terminate the ReTx-timer at the point D.

When the DL/UL communication operation for retransmission is successfully completed, and no other DL/UL communication operation occurs within an interval from the point D to the expiry of the Inact-timer, the terminal may perform the DRX operation after the end of the on-duration #2 according to a preconfigured DRX cycle and DRX parameter(s). Here, the active time may be a time interval from the starting time (e.g., point B) of the downlink monitoring operation to the ending time (e.g., point F) of the on-duration #n+1.

Meanwhile, the following may be additionally considered in the relationship between the retransmission operation and the DRX operation according to HARQ.
Downlink radio resource bundling allocation
Uplink radio resource bundling allocation
HARQ deactivation (or, disable) function

In the downlink radio resource or uplink radio resource bundling allocation, a DL/UL communication operation (e.g., step S701, step S801) may be performed in a plurality of radio resources (e.g., a plurality of slots) according to a plurality of scheduling periodicities. For example, the DL/UL communication operation may be performed based on a repetition scheduling scheme. When the bundling allocation scheme (or repetitive scheduling scheme) is used, the operation of (re)starting or stopping each of the H-RTT-timer shown in FIG. 7 (e.g., terrestrial H-RTT-timer), the H-RTT-timer shown in FIG. 8 (e.g., non-terrestrial H-RTT-timer), and the ReTx-timer may not be performed.

For example, the terminal may start the Inact-timer at the ending time (e.g., the last occurrence time) of the DL/UL communication operation (e.g., step S701, step S801) according to the bundling allocation scheme (or repetitive scheduling scheme). When the downlink reception operation or the uplink transmission operation is not performed until the Inact-timer expires, or when the on-duration (e.g., on-duration #2 shown in FIG. 8) ends, the terminal may perform a DRX operation based on a preconfigured DRX cycle and DRX parameter(s). Here, the ending time (e.g., the last occurrence time) of the DL/UL communication operation according to the bundling allocation scheme (or repetitive scheduling scheme) may be a time of the DL/UL communication operation according to the last bundling allocation (or last repetitive scheduling) or a downlink reception time (or uplink transmission time) according to the last repetitive scheduling (or last bundling allocation).

The HARQ deactivation function may mean that the HARQ function is deactivated in a data transmission procedure between the non-terrestrial node and the terminal. The HARQ deactivation function may be applied to each HARQ processes (e.g., HARQ process ID or HARQ process number), logical channel, transport block, or code block. Even when the HARQ function is deactivated in the data transmission procedure, the operation of (re)starting or stopping each of the H-RTT-timer shown in FIG. 7 (e.g., terrestrial H-RTT-timer), the H-RTT-timer shown in FIG. 8 (e.g., non-terrestrial H-RTT-timer), and/or the ReTx-timer may not be performed. When the HARQ function is deactivated, the terminal may start the Inact-timer at a time when the DL/UL communication operation is performed. When a downlink reception operation or an uplink transmission operation is not performed until the Inact-timer expires, or when the on-duration (e.g., on-duration #2 shown in FIG. 8) ends, the terminal may perform a DRX operation based on a preconfigured DRX cycle and DRX parameter(s).

Meanwhile, the DRX operation for reducing power consumption of the terminal in the non-terrestrial network may be performed based on a control message instead of the timer(s) shown in FIGS. 7 and 8. For example, the non-terrestrial node may transmit a PHY message and/or a MAC message indicating execution of the DRX operation to the terminal. The PHY message may be DCI transmitted through a PDCCH. A specific field included in the DCI may indicate execution of the DRX operation. Alternatively, the PHY message may be a reference signal indicating execution of the DRX operation. Each of the PHY message and the MAC message indicating execution of the DRX operation may include information indicating when the DRX operation is performed. The information indicating a time when the DRX operation is performed may indicate the starting time of the on-duration. Alternatively, the information indicating the time when the DRX operation is performed may indicate an offset between a reception time of the control message (e.g., PHY message or MAC message) including the information and the starting time of the on-duration. The information indicating the time when the DRX operation is performed may be configured in units of a slot, mini-slot, slot, subframe, or radio frame. Alternatively, the information indicating the time when the DRX operation is performed may be configured in absolute time

The terminal may receive the control message indicating execution of the DRX operation from the non-terrestrial node, and perform the DRX operation according to a preconfigured DRX cycle and DRX parameter(s) without using the timer (e.g., Inact-timer, H-RTT-timer) for the DRX operation. In this case, the terminal may perform a downlink monitoring operation within the on-duration according to the DRX cycle to receive downlink data. The non-terrestrial node may perform a DL/UL communication operation in the on-duration according to the DRX cycle. The control message indicating execution of the DRX operation may indicate to perform the DRX operation at the ending time of the DL/UL communication operation. Here, the ending time of the DL/UL communication operation may be the same as the starting time of the DRX operation. Alternatively, the control message indicating execution of the DRX operation may indicate that the DRX operation is to be performed when the on-duration ends after the DL/UL communication operation is completed.

The time (e.g., starting time, restarting time, ending time, stopping time) of each of the above-described timer, offset, counter, time interval, and cycle may be configured in units of a symbol, mini-slot, slot, subframe, or radio frame. Alternatively, the time (e.g., starting time, restarting time, ending time, stopping time) of each of the timer, offset, counter, time interval, and cycle may be configured in absolute time units (e.g., milliseconds, microseconds).

Meanwhile, the above-described non-terrestrial node (e.g., non-terrestrial cell) may be a base station. The non-terrestrial node may refer to a node B (NodeB), an evolved NodeB, a base transceiver station (BTS), a radio base station, a radio transceiver, an access point, an access node, a road side unit (RSU), a radio remote head (RRH), a transmission point (TP), a transmission and reception point (TRP), or a gNB.

In the present disclosure, the terminal may refer to a UE, a terminal, an access terminal, a mobile terminal, a station, a subscriber station, a mobile station, a portable subscriber station, a node, a device, an Internet of Thing (IoT) device, or a mounted apparatus (e.g., a mounted module/device/terminal or an on-board device/terminal).

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal in a non-terrestrial network, the operation method comprising:
when a transmission operation of downlink data is started in an on-duration according to a discontinuous reception (DRX) cycle, starting a first timer indicating a first time interval required for a retransmission operation of the downlink data;
starting a second timer when the first timer expires;
performing a downlink monitoring operation in a second time interval according to the second timer; and
when control information for the retransmission operation is received from a non-terrestrial node in the second time interval, receiving the downlink data from the non-terrestrial node in a downlink resource indicated by the control information,
wherein the first timer is configured in consideration of a transmission delay between the non-terrestrial node and the terminal.

2. The operation method according to claim 1, wherein the first timer is configured for each hybrid automatic repeat request (HARQ) process in the non-terrestrial network.

3. The operation method according to claim 1, wherein the first time interval is a minimum time interval required to allocate the downlink resource for the retransmission operation in the non-terrestrial network.

4. The operation method according to claim 1, wherein a length of the first time interval is set to a multiple of the DRX cycle.

5. The operation method according to claim 1, wherein an ending time of the first time interval is set to a starting time of the on-duration, an ending time of the on-duration, or an arbitrary time within the on-duration.

6. The operation method according to claim 1, wherein the first time interval is a sum of a minimum time interval required to allocate the downlink resource for the retransmission operation in a terrestrial network and the transmission delay.

7. The operation method according to claim 1, wherein the first timer is stopped when the transmission operation is completed successfully, and the first timer continues to operate when the transmission operation fails.

8. The operation method according to claim 1, wherein the second timer is stopped when the control information for the retransmission operation is received from the non-terrestrial node.

9. The operation method according to claim 1, further comprising receiving, from the non-terrestrial node, a message including information of the first timer and information of the second timer.

10. A terminal in a non-terrestrial network, the terminal comprising:
a processor;
a memory electronically communicating with the processor; and
instructions stored in the memory,
wherein when the instructions are executed by the processor, the instructions cause the terminal to:
when a transmission operation of uplink data is started in an on-duration according to a discontinuous reception (DRX) cycle, start a first timer indicating a first time interval required for a retransmission operation of the uplink data;
start a second timer when the first timer expires; and
retransmit the uplink data to a non-terrestrial node by using an uplink resource in a second time interval according to the second timer,
wherein the first timer is configured in consideration of a transmission delay between the non-terrestrial node and the terminal.

11. The terminal according to claim 10, wherein the first timer is configured for each hybrid automatic repeat request (HARQ) process in the non-terrestrial network.

12. The terminal according to claim 10, wherein the first time interval is a minimum time interval required to allocate the downlink resource for the retransmission operation in the non-terrestrial network, and a length of the first time interval is set to a multiple of the DRX cycle.

13. The terminal according to claim 10, wherein an ending time of the first time interval is set to a starting time of the on-duration, an ending time of the on-duration, or an arbitrary time within the on-duration.

14. The terminal according to claim 10, wherein the first time interval is a sum of a minimum time interval required to allocate the downlink resource for the retransmission operation in a terrestrial network and the transmission delay.

15. The terminal according to claim 10, wherein the uplink resource is a radio resource indicated by downlink control information (DCI) received from the non-terrestrial node in the second time interval or a configured grant (CG) resource.

16. The terminal according to claim 10, wherein the instructions further cause the terminal to receive, from the non-terrestrial node, a message including information of the first timer and information of the second timer.

17. An operation method of a non-terrestrial node in a non-terrestrial network, the operation method comprising:
transmitting, to a terminal, a message including information of a first timer indicating a first time interval required for a retransmission operation of downlink data and information of a second timer indicating a second time interval in which a downlink monitoring operation is performed;
performing a transmission operation of the downlink data in an on-duration according to a discontinuous reception (DRX) cycle; and
when the transmission operation fails, transmitting control information for the retransmission operation to the terminal in the second time interval after the first time interval,
wherein the first time interval starts from a time of performing the transmission operation, the second time interval starts from an ending time of the first time interval, and the first timer is configured in consideration of a transmission delay between the non-terrestrial node and the terminal.

18. The operation method according to claim 17, wherein the first time interval is a minimum time interval required to allocate the downlink resource for the retransmission operation in the non-terrestrial network, and a length of the first time interval is set to a multiple of the DRX cycle.

19. The operation method according to claim 17, wherein an ending time of the first time interval is set to a starting time of the on-duration, an ending time of the on-duration, or an arbitrary time within the on-duration.

20. The operation method according to claim 17, wherein the first time interval is a sum of a minimum time interval required to allocate the downlink resource for the retransmission operation in a terrestrial network and the transmission delay.
